(19) United States
(12) Patent Application Publication
(10) Pub. No.: US 2021/0273848 A1
(43) Pub. Date: Sep. 2, 2021

(54) ALERT AND DISASTER MANAGEMENT SYSTEM AND METHOD FOR OPERATING SUCH A SYSTEM

(71) Applicant: Thierry Fayard, Toulouse (FR)

(72) Inventor: Thierry Fayard, Toulouse (FR)

(21) Appl. No.: 16/762,579

(22) PCT Filed: Nov. 17, 2017
(86) PCT No.: PCT/FR2017/053160

§ 371 Date: May 12, 2021

(51) Int. Cl. H04L 12/24; H04J 3/06; G08B 21/10; G08B 25/08; G08B 25/14; H04W 4/029

(52) U.S. Cl. CPC H04L 41/0677; H04J 3/0635; H04W 4/029; G08B 25/08; G08B 25/14; G08B 21/10

(57) ABSTRACT

The alert and disaster management System (100) comprises: at least one radiocommunication terminal (105), the terminal comprising: a means (106) for communicating, via a data network, with a central computer system, —a sensor (110) for sensing a value of a physical variable that is representative of the operation of the network connected to the terminal, a means (115) for determining a network failure according to the captured value, a transmitter (120) of radio signals in the event a failure is determined and —the central computer system (300), connected via the data network to at least one terminal, comprising: a memory (304) of geographical positioning information of at least one terminal, a detector (305) for detecting network connection anomalies between the computer system and at least one terminal, a means (310) of providing an alert in the event of an anomaly, a means (315) of providing a piece of information that represents the stored positioning of at least one said terminal having a network connection anomaly and at least one mobile radiocommunication receiver (125) configured to receive the radio signals transmitted by at least one terminal.

### TECHNICAL FIELD OF THE INVENTION

In general, the invention belongs to the field of emergency aid in case of disaster.

### PRIOR ART

The known techniques for multiplexing radiocommunication signals comprise in particular:
frequency division multiple access (FDMA), a technique which uses a slicing of the shared frequency band into sub-bands, which are allotted (normally in a dynamic manner) to the various terminals,
time division multiple access (TDMA), a technique according to which the terminals emit during certain timeslots which are allotted to them, so as to reduce the probability of “collisions” (of interference) between the emissions of various terminals and
code division multiple access (CDMA), which operates by spreading the emission spectrum by means of mutually orthogonal codes.

These techniques can, to a certain extent, be combined.

To access the data transmitted by a terminal, the receiver must know in advance the transmission channel or channels used by the terminal. Each of these techniques therefore rests on the predictability of the allotting of the physical channels (frequency sub-band, transmission slots or spreading code) to the various terminals. Except for the cases where the allotting of the channels is static, a certain synchronization between the emitters and the receivers is necessary. The requirements in terms of synchronization depend on several factors, in particular on the frequency of channel changes, on the temporal density of the messages on the shared frequency band, possibly on the redundancy of the messages, etc.

Document FR 2 961 046 A1 indicates that the allotting mechanisms are incompatible with very low bitrate (of the order of a few bits per second) telecommunications systems, because these bitrates are insufficient to maintain the synchronization between terminals from which the messages emanate and a data collection station. This document FR 2 961 046 A1 proposes as solution to this problem to configure the terminals in a static manner so that they transmit radioelectric signals in a single predefined frequency sub-band or in accordance with a predefined sequence of frequency sub-bands. Temporal or frequency synchronization of the terminals with one another and with the collection station is not considered necessary. Consequently, the collection station must be capable of detecting any radioelectric signal appearing in the shared frequency band and of determining whether the detected signals correspond to signals emitted by terminals or to third-party or parasitic signals.

One of the objectives of FR 2 961 046 A1 is to guarantee a low level of collisions between radioelectric signals emitted by different terminals. However, given the absence of any synchronization between the terminals, the only means of maintaining a low level of collisions for a given frequency and a given duration of messages is to limit the geographical density of the terminals. Actually, the more the number of terminals increases, the more the probability of collisions and therefore the loss of data also increases. This fact could curb the massive deployment of machine-to-machine (“M2M”) communication terminals and/or of the Internet of Things, using for example UNB radio technology (the acronym standing for the English term “Ultra Narrow Band”).

Moreover, after an earthquake, a storm, flooding, or an industrial accident on a dangerous site, power is, in general, no longer available, and the communication means become inoperative just when they are most useful, or else they very quickly become saturated.

Therefore the organization of emergency aid, the management of priorities, the relevant allotting of means are rendered very difficult. The management of information distributed over a zone and its transport to decision centers is critical. It becomes necessary for means of robust and resilient communications to be available, capable of effectively informing a decision maker.

To cope with this type of difficulty, systems are known which implement low-frequency, of the order of 200 MHz, walkie-talkies exhibiting possibilities of extending the range of a frequency segment to 5 to 8 kilometers. These systems make it possible to create meshed networks.

Today, no means exists for organizing the response to a disaster in an automated manner and, in particular, no means exists for organizing the presence of numerous emitters to be managed simultaneously while avoiding collisions of messages on a possibly extensive zone or indeed a region.

### OBJECT OF THE INVENTION

The present invention is aimed at remedying all or some of these drawbacks.

To this effect, the present invention envisages a system for alert and disaster management, which comprises:
at least one radiocommunication terminal, the terminal comprising:
   a means of communication, via a data network, with a central computer system,
   a sensor of a value of a physical quantity representative of the operation of the network connected to the terminal,
   a means for determining a failure of the network as a function of the sensed value,
   a transmitter of radio signals in case of failure determination and
the central computer system, linked via the data network to at least one terminal, comprising:
   a memory for information in respect of geographical positioning of at least one terminal,
   a detector of anomaly of network link between the computer system and at least one terminal,
   a means for providing an alert in case of anomaly,
   a means for providing an item of information representative of the stored positioning of at least one said terminal exhibiting a network link anomaly and
at least one mobile radiocommunication receiver configured to receive the radio signals emitted by at least one terminal.

By virtue of these arrangements, the detection of a disaster is carried out in an automatic manner by tracking of the network by the communication terminal on the one hand and by the computer system on the other hand, irrespective of the type of disaster envisaged. In case of disaster, the provision of an alert makes it possible through the computer system, manually or automatically, to deploy each mobile receiver with a view to collecting data provided by the terminals. Thus, the item of geographical positioning information can be displayed on a screen, for example, so that an operator takes cognizance thereof or else provided to a system for itinerary preparation of the mobile receiver.

This makes it possible, in particular, to ensure the maintaining of the transmission of data captured by the terminals between a mode in which the terminal is linked to the central computer system by the data network and a mode in which the terminal is linked to the central computer system by way of the receiver. As is understood, the receiver and the central computer system can be merged into a single device.

The, mobile, receiver collects the failure signals emitted by the communication terminals so as to record them or dispatch them toward a central collection computer system.

Thus, as understood, the terminals exhibit two modes of operation:
a first so-called “normal” mode of operation, in which direct communication between terminal and central computer system takes place and
a second so-called “alert” mode of operation in which communication is indirect, that is to say passes through a receiver.

This does not prevent the receiver and the communication means from implementing the same communication technique.

It is noted that the present invention also envisages a system for alert and disaster management, which comprises:
at least one radiocommunication terminal, the terminal comprising:
   a sensor of a value of a physical quantity representative of operation of the network connected to the terminal,
   a means for determining a failure of the network as a function of the sensed value,
   a transmitter of radio signals in case of failure determination and
at least one mobile radiocommunication receiver configured to receive the radio signals emitted by at least one terminal.

In these variants, the deployment of each receiver is carried out manually.

It is noted that the present invention also envisages a system for alert and disaster management, which comprises:
at least one radiocommunication terminal, the terminal comprising:
   a sensor of a value of a physical quantity,
   a transmitter of radio signals representative of said physical quantity and
at least one mobile radiocommunication receiver configured to receive the radio signals emitted by at least one terminal.

In embodiments the computer system comprises a device for preparing an itinerary of at least one receiver, the itinerary being established as a function of at least one item of geographical positioning information provided.

In embodiments, the computer system comprises a satellite control device, said satellite forming receiver.

In these variants, the terminal emits in a continuous or pseudo-continuous manner, radio signals destined for a receiver.

In embodiments, the sensor senses a physical quantity representative of an Internet network.

In embodiments, the sensor senses a physical quantity representative of an electrical grid.

These embodiments appertain to the detection of a failure in a specific network.

In embodiments, the signals transmitter implements a time division multiple access communication protocol.

In embodiments, at least one terminal is configured to maintain the phase-wise timing of timeslots of the time division multiple access communication protocol in case of outage of access of the terminal to an external signal allowing the terminal to determine a timing phase for the timeslots.

In embodiments, at least one terminal comprises a clock as well as a synchronization device linked to the Internet network, the synchronization device being configured to synchronize the clock with the Internet network.

In embodiments, at least one terminal comprises a clock as well as a synchronization device linked to a clock radio-transmission system, the synchronization device being configured to synchronize the clock with the clock radio-transmission system.

In embodiments, at least one terminal comprises a clock as well as a synchronization device linked to a satellite-based position system, the synchronization device being configured to synchronize the clock with the satellite-based position system.

In embodiments, at least one radiocommunication terminal is configured to dispatch radiocommunication signals in a shared frequency band, said terminal comprising a sensor of phase of an electrical grid connected to the terminal, said terminal being configured to carry out a temporal division of the shared frequency band into several timeslots per period of the electrical grid, each timeslot having a known ratio to the phase of the electrical grid, the transmitter being configured to transmit on the shared frequency band in the timeslots in compliance with a time division multiple access (TDMA) schedule.

In embodiments, at least one terminal comprises a clock as well as a phase synchronization device linked to the sensor of phase of the electrical grid.

In embodiments, at least one terminal comprises an energy reserve allowing the terminal to operate in an autonomous manner.

In embodiments, at least one terminal is configured to maintain the phase-wise timing of the timeslots in case of outage of the electrical grid or in case of abrupt change of the phase of the electrical grid.

In embodiments, the sensor of phase of the electrical grid comprises a connector that can be hooked up to the electrical grid.

In embodiments, the sensor of phase of the electrical grid comprises an antenna to pick up the oscillations of the electrical grid.

In embodiments, at least one terminal comprises a wired or wireless communication module to connect to a local network and/or to the Internet.

In embodiments, at least one terminal comprises a wired or wireless communication module to connect to sensors, receive data from these sensors and upload the data to a serving station via the radiocommunication signals in the shared frequency band.

In embodiments, at least one terminal comprises a buffer memory to save data of connected sensors.

In embodiments, the receiver is configured to listen to the shared frequency band.

In embodiments, the receiver is mounted on a vehicle.

In embodiments, the vehicle is a drone, a car, a satellite or an airplane.

In embodiments, at least one receiver comprises an emitter of a command to stop transmission directed to at least one terminal, each terminal ceasing to transmit signals on receipt of said command.

In embodiments, at least one sensor linked to at least one terminal, the transmitter being configured to emit an item of information representative of a value sensed by at least one said sensor.

In embodiments, at least one sensor is a mobile telephone presence sensor.

In embodiments, at least one terminal comprises:
a receiver of message emitted on a local network including said terminal, preferentially wireless and
a memory for at least one said message,

the transmitter being configured to emit at least one signal representative of at least one said message.

In embodiments, the system which is the subject of the present invention comprises a plurality of terminals, at least two of which terminals are linked together by a radiocommunication link, at least one terminal forming concentrator of signals emitted by the two said terminals.

According to a second aspect, the present invention envisages a method of operation of a system which is the subject of the present invention, which comprises:
a step of positioning at least one terminal,
a step of communication, via a data network, between the central computer system and at least one terminal and
at the level of the terminal:
   a step of sensing a value of a physical quantity representative of the operation of the network connected to the terminal,
   a step of determining a failure of the network as a function of the sensed value,
   a step of transmitting radio signals in case of failure determination and
at the level of the central computer system:
   a step of detecting anomaly of network link between the computer system and at least one terminal and
   a step of providing an alert in case of anomaly and
a step of radiocommunication mobile reception configured to receive the radio signals emitted by at least one terminal.

As is understood, the advantages related to the use of the method are equivalent to the advantages of the system which is the subject of the present invention.

Thus, the present invention also relates to a method of radiocommunication in a shared frequency band between several terminals and a serving station. It is noted that the terms “serving station” and “radiocommunications receiver”, such as defined in the first aspect of the present invention, are here considered to be synonyms. The method comprises the synchronization of the terminals and, optionally, of the receiver with one and the same alternating current (mains) electrical grid. By transitivity, all the terminals (and optionally the station) are synchronized with one another. According to the method, the terminals emit on the shared frequency band while complying with a time division multiple access (TDMA) schedule.

The definition of the access schedules can depend on clocks arising:
from the Internet network,
from a clock radio-transmission system,
from a satellite-based positioning system or
from the electrical grid linked to each radiocommunication terminal.

It is noted that the serving station can be synchronized to the network and know the TDMA schedule but this is not obligatory. Indeed, it is possible to choose as serving station a broadband station capable of receiving the entirety of the shared frequency band and of digitizing it (if relevant after transposition to an intermediate frequency). Demodulation and access to the messages can be carried out by software and/or on a signals processor.

The method uses the mains as a reference clock. It is the merit of the inventor to have recognized that the, virtually ubiquitous, electrical grid lends itself to this type of application. It is indeed relatively little known that the mains frequency (normally 50 Hz or 60 Hz) is remarkably stable on account of the efforts of electrical energy suppliers to contain distortions within very narrow limits. Another finding is that the phase of the electrical grid exhibits very little variation as a function of place as long as they are fed by one and the same transformer or, in case of divergence, vary little and are measurable over time. In the context of the invention, this signifies that the synchronization of the terminals and, optionally, of the serving stations, can cover sizable geographical zones (for example from a few tens to a few hundred kilometers in diameter.)

In the context of the method, the TDMA schedule designates the timetable (that is to say the positioning of the slots with respect to the time reference) defining which terminal is entitled to use which timeslot(s) for the transmission of its messages. It goes without saying that compliance with a TDMA schedule signifies for each terminal that this terminal limits its emissions within the slots which are allotted to it. In particular, the bounds of the slots must be complied with by each terminal. For a given terminal, the schedule is advantageously static, that is to say fixed once and for all, for example in the factory or, more advantageously, when brought into service at the place of installation, preferably as a function of the use of the slots by other geographically neighboring terminals. However, nothing excludes a terminal being able to be reconfigured subsequently, for example if it turns out that some other allocation of the slots would make it possible to further reduce the risk of message collisions. As a whole, the schedule is supplemented each time a terminal is added to the system. The schedule can take the form of a database stored in a centralized or decentralized manner. The terminals are preferably identified therein by a unique identifier. The geographical coordinates of the place of installation are preferably cataloged, which, in case of a terminal being added, makes it possible to allocate it one or more timeslots as a function of the allocation of slots to the geographically neighboring terminals already in place and/or as a function of an optimization of the use of the resources with a view to a projected distribution of terminals. It is also possible to allocate the slots automatically, as a function, for example of the geographical coordinates. One possibility would be, for example, to enter the geographical coordinates of the terminal in a predefined format into a hash function the result of which determines the slot or slots in which the terminal is entitled to emit.

The TDMA schedule can make provision for a terminal to be entitled to access all the slots or a sub-group of slots in a random manner. It is therefore possible to define various groups of terminals or of access entitlements: certain terminals could be entitled to emit in a larger group of slots than others. The possibility of being able to allot higher or lower service levels makes it possible to create solutions specifically dedicated to various applications.

It should be noted that the TDMA approach such as employed in the context of the invention can be combined with an FDMA approach. In this case, the schedule defines which terminal is entitled to use which timeslot(s) and which sub-band of frequencies for the transmission of its messages. It will be appreciated that number of channels of a combined TDMA/FDMA approach will be equal to the product of the number of TDMA channels and of the number of frequency sub-bands.

It is noted that the number of slots per cycle of the alternating current of the electrical grid determines how many terminals can transmit “simultaneously” (on the scale of the cycle of the alternating current) at the maximum without there being any collision. However, if the number of slots increases, their duration decreases, and messages longer than a slot will have to be transmitted piecewise. Another limitation of the number of slots stems from the fact that the requirements in terms of synchronization increase with the number of slots.

As the electrical grid usually employs three phases (three-phase current) mutually shifted by 120°, there exists a priori an uncertainty as regards the phase to which a terminal is synchronized. In order to guarantee that all the terminals are nonetheless mutually synchronized, independently of this ambiguity, it is proposed to divide each period of the alternating current into a number N of slots which is a multiple of 3: N=3·n, where n is an integer greater than or equal to 2 designating the number of independent TDMA channels. For example, with n=5, each period of the alternating current is divided into 15 slots, which are allotted to 5 independent TDMA channels. The latter, denoted A to E hereinafter, are distributed per period of the alternating current according to the pattern A-B-C-D-E-A-B-C-D-E-A-B-C-D-E. It will be appreciated that the base pattern A-B-C-D-E repeats at triple the frequency of the alternating current. For a terminal which synchronizes to another phase of the three-phase network, the ±120° shift therefore has no impact.

It will be appreciated that the present invention finds an advantageous, although wholly non-limiting, application in the information collection systems (for example within the framework of an application of the Internet of Things), such as networks of sensors recurrently emitting data representative of the measured physical quantity or quantities destined for a data collection station. It is possible to cite, by way of example, onboard sensors embedded in electricity, gas or water meters, which would emit data relating to consumption to a collection station. It is also possible to cite domestic systems for remote monitoring and/or of sites at risk (Seveso classed sites for example) using distributed sensors. The terminals communicating with the serving stations can be integrated into the sensors or linked to the latter by any wired or wireless communication means. These sensors can in principle be of any type. For example, in the case of a search and rescue application, the sensors can be designed to monitor the number of people in a monitored zone so as to upload this item of information to an emergency aid coordination center in case of emergency situation. The terminals can henceforth be designed as people location radiobeacons.

In the context of the invention, by “serving station” or “collection station” is generally meant a receiver device suitable for receiving radioelectric signals in the shared frequency band, preferably in the entirety of the latter, for collecting the messages transmitted by the terminals and/or for retransmitting the messages or the data contained in said messages to their recipient. A serving station can comprise a relay antenna and/or represent an access point for a wired or non-wired telecommunications network. It will be understood that a serving station may be immobile or mobile.

Such a telecommunication terminal according to embodiments of the invention is intended to dispatch radiocommunication signals in a shared frequency band. It preferentially comprises a sensor (of angle) of phase (for example a phase comparator) of the electrical grid and is configured so as to carry out a temporal division of the shared frequency band into several timeslots per period of the electrical grid. Each timeslot has a known ratio to the phase of the electrical grid. The terminal is furthermore configured to transmit on the shared frequency band in the timeslots in compliance with a TDMA schedule.

The radiocommunication terminal comprises, preferably, a clock as well as a synchronization device linked to the electrical grid phase sensor, the synchronization device being configured to synchronize the clock with the electrical grid.

The radiocommunication terminal can comprise an energy reserve (one or more accumulators, batteries, or other) allowing the terminal to operate in an autonomous manner. The terminal can be fed with energy only by this reserve. According to another embodiment, it is fed by the electrical grid and the energy reserve is only used in case of current outage.

According to an advantageous embodiment, the terminal is configured to maintain the phase-wise timing of the timeslots in case of outage of the electrical grid. Within the framework of a radiocommunication method, it will be useful that all the terminals maintain the timing of the timeslots of the TDMA schedule in case of outage of the electrical grid or in case of abrupt change of the phase of the electrical grid. (An abrupt change of phase is due, with a certain probability, to the fact that an emergency generator has cut in—starting from this moment, it is no longer possible to assume, in general, that the supply of current is synchronous for all the terminals.) This embodiment has the advantage that all the terminals configured in this way remain mutually synchronized at least for a certain time if the supply of current is interrupted. The time that the terminals remain sufficiently synchronized depends on the quality of their internal clock and on the number of timeslots per cycle of the alternating current. If the terminals are equipped with a clock having a temporal precision of 10-8 (i.e. a mean drift of 10-8 s per s), sufficient synchronization can be maintained for a few hours.

According to one embodiment of the terminal, the electrical grid phase sensor comprises a connector that can be hooked up to the electrical grid. Alternatively or additionally, the electrical grid phase sensor can comprise an antenna (for example a ground loop) to pick up the oscillations of the remote electrical grid.

The radiocommunication terminal can comprise a wired communication module (for example an Ethernet module) or wireless communication module (for example a Wifi (Trademark) module, a Bluetooth (Trademark) module, a ZigBee (Trademark) module, etc. or a combined module compatible with several protocols) to connect to a local network and/or to the Internet.

According to one embodiment, the radiocommunication terminal is configured to pass to a distress mode (or alert mode) subsequent to a trigger event. A trigger event could be, for example, a failure of the electrical grid, the loss of an Internet connection, the detection of flooding, of an earthquake, of a tsunami, of a fire or of the presence of smoke. The radiocommunication terminal can comprise or be connected to sensors capable of detecting emergency situations. Alternatively or additionally, the terminal could be connected (by wire or wirelessly) to a center or a relay for broadcasting alert messages (e.g. as subscriber to a service for protecting the population or other.) Preferably, the terminal is configured, when it is switched into the distress mode, to emit emergency messages in the timeslot or slots which are allocated to it. The emergency messages contain, preferably, and to the extent of the availability thereof at the level of the terminal, information such as the number of people (liable to be) in distress, their state of health, the severity of the material damage, the geographical position of the terminal or people in danger, etc.

The radiocommunication terminal comprises, preferably, a wired or wireless communication module to connect to sensors, receive data from these sensors and upload the data to a serving station via the radiocommunication signals in the shared frequency band. In this case, a terminal serves as relay between the sensor or sensors and the serving station. According to another embodiment of the terminal, it is integrated with a sensor.

The radiocommunication terminal can comprise a buffer memory to save data of connected sensors. The terminal can be configured so as to place more recent data in memory in the event that such data are received from the sensors. As long as the terminal is not placed in distress mode (or alert mode), the more recent data can, as and when, replace the older data. If the terminal is placed in distress mode, the recording of new data can be suspended—in this case, the latest data collected before the triggering of the distress mode are considered to be the latest reliable data.

The present invention pertains, also, to a telecommunication system which comprises a plurality of terminals such as are described above and a serving station (or data collection station), the terminals and, optionally, the station being synchronized with one and the same electrical grid, the station comprising a receiver configured to listen to the shared frequency band. The station may optionally be endowed with a memory comprising the TDMA schedule.

The serving station can be static (that is to say immobile) or movable. According to one embodiment, the serving station is mounted on a vehicle, e.g. a drone or a car. A possible application of such a system would for example be the remote reading of electricity, gas or water meters by way of a drone overflying the zone provided with electricity, gas or water, or of a terrestrial vehicle (motorbike, car, pushbike, etc.) going along the streets. It will be appreciated that such a system makes it possible to considerably reduce the cost of logging the meters.

It will be appreciated that the invention is of particular interest not only in the case of fixed terminals and of a mobile serving station but for all the applications, in which there may be a relative motion between a terminal and a serving station and limited durations of visibility between the terminals and the serving station. It is possible, for example, to employ the system within the framework of a race (on foot, cycling or other), in particular to transmit telemetry data tapped off from participants to a monitoring center (for example a medical monitoring center).

### BRIEF DESCRIPTION OF THE FIGURES

Other advantages, aims and particular characteristics of the invention will emerge from the nonlimiting description which follows of at least one particular embodiment of the device and of the method which are the subject of the present invention, in relation to the appended drawings, in which:

FIG. 1 is a basic illustration of a telecommunications system according to one embodiment of the invention,

FIG. 2 is schematic illustration of an “intelligent” house equipped with a terminal according to one aspect of the invention,

FIG. 3 is a schematic illustration of a use of a telecommunication system according to one embodiment of the invention within the framework of an emergency situation,

FIG. 4 is a schematic illustration of a house equipped with intelligent electricity gas and water meters, configured as terminals compliant with an aspect of the invention,

FIG. 5 is a timechart illustrating the synchronization of a telecommunication system with the electrical grid,

FIG. 6 is a schematic illustration of the system which is the subject of the present invention and

FIG. 7 is a schematic illustration of the method which is the subject of the present invention.

### DESCRIPTION OF EXEMPLARY EMBODIMENTS OF THE INVENTION

The present description is given without implied limitation, each characteristic of one embodiment being able to be combined with any other characteristic of any other embodiment in an advantageous manner.

It is noted henceforth that the figures are not to scale.

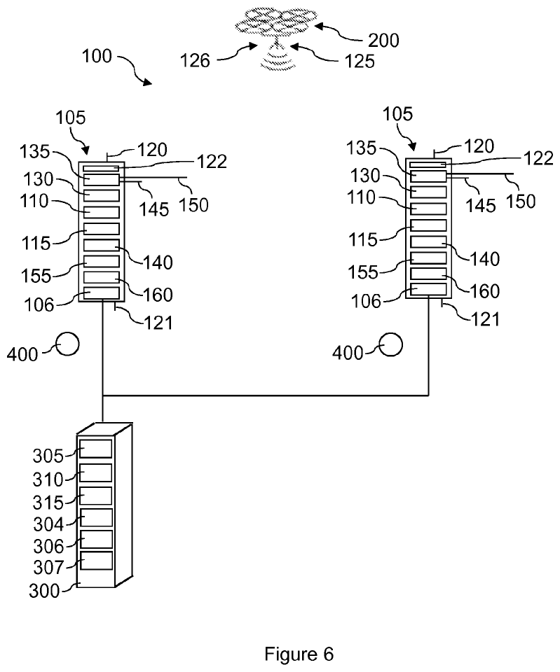

A particular embodiment of the system 100 which is the subject of the present invention is observed in FIG. 6. This alert and disaster management system 100, comprises:
at least one radiocommunication terminal 105, the terminal comprising:
   a means 106 of communication, via a data network, with a central computer system,
   a sensor 110 of a value of a physical quantity representative of the operation of the network connected to the terminal,
   a means 115 for determining a failure of the network as a function of the sensed value,
   a transmitter 120 of radio signals in case of failure determination and
the central computer system 300, linked via the data network to at least one terminal, comprising:
   a memory 304 for information in respect of geographical positioning of at least one terminal,
   a detector 305 of anomaly of network link between the computer system and at least one terminal,
   a means 310 for providing an alert in case of anomaly,
   a means 315 for providing an item of information representative of the stored positioning of at least one said terminal exhibiting a network link anomaly and
at least one mobile radiocommunication receiver 125 configured to receive the radio signals emitted by at least one terminal.

The term “terminal” 105 designates any device able to emit, and optionally to receive, communication signals according to two channels:
according to a first channel formed by the means 106 of communication and the data network and
according to a second channel formed by the transmitter 120 of radio signals and of the receiver 125.

In variants, the means 106 of communication and the transmitter 120 can be merged.

Preferentially, each terminal 105 is unitary, that is to say that the set of components of this terminal is integrated into a single casing. However, the terminal 110 can also be modular and, in this case, each component can be distributed in a plurality of devices communicating with one another. Each terminal 105 can, thus, implement a nano-computer, of Raspberry PI (trademark) type.

Preferentially, the terminal 105 comprises a thermally insulating casing which is fireproof and/or gastight and/or watertight. The person skilled in the art can, here, draw inspiration from the characteristics of black boxes in the field of aeronautics.

In a schematic manner, the function of each terminal 105 consists in tracking the evolution of a value which is determined, as a function of the terminal 105, and of determining as a function of this value the presence of a failure of a network. When a failure is detected, the terminal 105 passes to an “alert” mode and transmits an item of information representative of the detection of this failure or else an item of information representative of a value sensed elsewhere by the terminal 105. Said value depends on at least one third-party sensor, external or internal, to the terminal 105. Each third-party sensor can be of any type, such as:
a presence sensor,
a sensor of a determined physical quantity,
a sensor of presence of mobile telephones in proximity,
a sensor of presence of peripherals associated with a Wifi or Bluetooth network in proximity.

According to the applications, the terminal 105 can also communicate the values sensed by the third-party sensors by virtue of the means 106 of communication. This means 106 of communication is of wired or wireless type and suitable for communicating over the Internet or a cellular data network, for example.

This allows the terminal 105, in case of disaster, to continue to emit signals toward the central computer system, through at least one receiver 125.

The central computer system 300 is customarily linked to at least one terminal 105 by way of the data network considered. Thus, computer system 300 and terminals 105 exchange data in a usual manner, in a unilateral or bilateral manner.

The computer system 300 is furnished with a detector 305 of anomaly of network link between the computer system and at least one terminal 105. This anomaly detector 305 depends on the type of data network considered. For example, this anomaly detector 305 can be software embedded in an electronic card linked to an interface, wired or wireless, for receiving signals arising from the data network. This software, detecting an absence of signals originating from a terminal 105, subsequent to the emission or otherwise of a request by the system 300, detects an anomaly. When a determined number of anomalies is detected by the detector 305, the system 300 passes to an alert mode, representative of a break of link with at least one terminal 105.

In case of alert, the means 310 for providing an alert provides, for example, a signal allowing the emission of an audible and/or visual alert signal to an operator. This allows the operator to command the setting into operation of at least one receiver 125 with a view to collecting data arising from at least one terminal 105 under break of link.

In case of alert, the means 315 for providing an item of geographical positioning information provides an item of information, stored by the computer system 300, in respect of geographical positioning of at least one terminal 105. This item of information can be:
displayed on a screen,
transmitted to a device for preparing an itinerary of a receiver 125, for example mounted on an autonomous vehicle such as a drone,
transmitted to a satellite control device.

In case of display on a screen, an input by a user can serve as confirmation of emission of a command for deploying at least one receiver 125. The device for preparing a receiver 125 itinerary is, for example, a GPS navigation system embedded onboard the receiver 125.

Thus, as is understood, in embodiments, the computer system 300 comprises a device 306 for preparing an itinerary of at least one receiver 125, the itinerary being established as a function of at least one item of geographical positioning information provided.

This preparation device 306 is, for example, software configured to transmit the geographical coordinates of the terminals to a receiver 125 and/or to transmit an itinerary calculated at the level of the computer system 300. This device 306 includes, in variants, the system for communication between the computer system 300 and the receiver 125.

Thus, as is understood, in embodiments, the computer system 300 comprises a satellite control device 307, said satellite forming receiver 125.

This preparation device 307 is, for example, software configured to transmit the geographical coordinates of the terminals to a satellite forming receiver 125. This device 307 includes, in variants, the system for communication between the computer system 300 and the receiver 125.

In variants, the computer system 300 comprises a means for receiving a command (not referenced) for deployment of at least one receiver 125, such as a man-machine interface of any type. When a deployment command is received by the system 300, at least one receiver 125 is put into operation by the computer system 300. If this receiver 125 is mounted on an automatic vehicle, such as a drone, this automatic vehicle is directed toward a geographical zone where the terminal 105 is situated. Preferentially, at least one terminal 105 is thus geolocated. Alternatively, the receiver 125 can be a satellite placed in a state of active listening to the geographical zone.

Thus, as is understood, the system 100 which is the subject of the present invention makes it possible to measure the geographical impact of a disaster as a function of geographically distributed terminals 105 and to react immediately by deploying receivers 125 able to collect data emitted by said terminals 105.

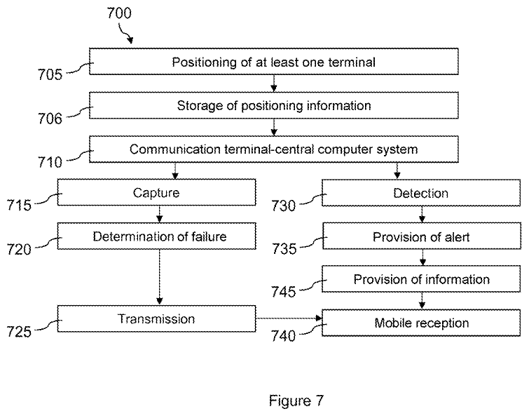

This manner of operation is represented in FIG. 7.

In two particular embodiments envisaged, the function of the terminal 105 is to determine a failure of the Internet network or of the electrical grid.

When the function of the terminal 105 is to determine the failure of the Internet network, the sensor 110 is, for example, a network card coupled to a micro-processor, the micro-processor periodically commanding the network card to emit a request of “ping” type to a determined IP address. Alternatively, the network card can simply measure the periodic reception of packets contained in signals emitted by an Internet network access point, such as a set-top box within the framework of a Wifi link of the terminal 105. Thus, any value intrinsic to the Internet network can be sensed by the sensor 110, according to the preferences of the person skilled in the art to the case of application of the system 100.

The determination means 115 is in this case, for example, formed of software embedded on board the micro-processor and charged with ensuring the tracking of the value sensed by the sensor 110. As a function of a predetermined evolution, or adaptive evolution, that is to say evolving slowly with respect to the evolutions of the sensed value, the determination means 115 determines a failure of the Internet network.

For example, if the sensor 110 senses the reception of a response to a request of ping type to a determined IP address, the request being emitted at a regular interval by the terminal 105, an absence of response to the request for several consecutive intervals gives rise to the determination of a failure of the Internet network by the determination means 115.

When the function of the terminal 110 is to determine the failure of an electrical grid to which the terminal 110 is linked, the sensor 115 comprises, for example, a connector 145 that can be hooked up to the electrical grid and/or an antenna 150 to pick up the oscillations of the electrical grid. The sensed value is, for example, the oscillation phase of the voltage of the electric current or the power of said electric current. Thus, for example, in case of strong phase variation, the determination means 115 is liable to determine that a generator has been turned on.

The determination means 115 is in this case, for example, formed of software embedded on board the micro-processor and charged with ensuring the tracking of the value sensed by the sensor 110. As a function of a predetermined evolution, or adaptive evolution, that is to say evolving slowly with respect to the evolutions of the sensed value, the determination means 115 determines a failure of the electrical grid.

For example, if the sensor 110 senses an oscillation phase of the electrical voltage provided by the electrical grid, a gross change of said phase of the voltage gives rise to the determination of a failure of the electrical grid by the determination means 115.

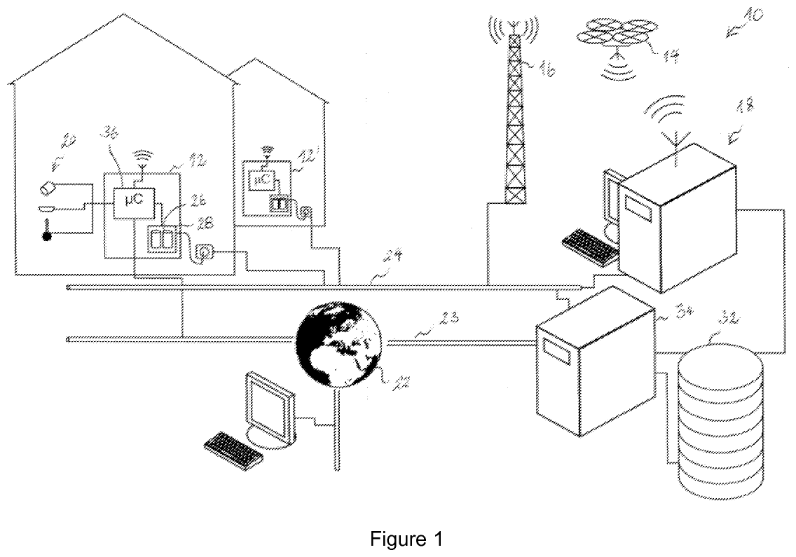

An example of such a terminal 105 is provided in FIG. 1, at the reference 12 and 12′.

It is noted, moreover, that the terminal 105 can also be configured to detect the failure of a telephone network or of a cellular data network.

Upstream or downstream of the determination of a failure of the network, the terminal 105 can also implement a sensor (not referenced) of any physical value, such as a presence detector, a thermometer, a barometer or other according to the operator's desired application of the terminal 105.

If the terminal 105 determines a failure of the network, an item of information representative of this detection and/or an item of information representative of the sensed physical value is transmitted to the receiver 125. The transmitter 120 is, for example, an antenna configured to emit wireless signals destined for the receiver 125. This transmitter 120 is configured to transmit wireless signals on a frequency band lying between 222 and 225 MHz, for example. Preferentially, the transmitter 120 is an omnidirectional antenna making it possible, irrespective of the positioning and the inclination of the terminal 105, to emit radio signals.

In variants, if the terminal 105 determines a failure of the network, this terminal 105 actuates a human-presence detector and transmits an item of information representative of the number of presences detected to the receiver 125. Such a detector is, for example, a sensor of presence of mobile telephones in proximity to the terminal 105. Such a presence sensor implements, for example, an antenna configured to receive signals emitted on a cellular telephone network frequency and a detector of a signal power received by said antenna, a presence being determined for each signal whose said signal power received is greater than a determined limit value.

The receiver 125 is a communication means able to receive the signals emitted by each transmitter 120. This receiver 125 comprises, for example, an antenna for receiving wireless signals. The term “receiver” 125 is synonymous with the term “serving station” such as described in relation to FIGS. 1 to 5. Thus, it is noted that the receiver 125 can comprise a memory for received information and/or a means for transmitting said information destined for a dedicated computer system, such as an antenna for transmitting wireless signals for example. In variants, the receiver 125 also comprises a dynamic spectrum detector and/or a modulation presence detector. Such a receiver 125 is, for example, a drone comprising a broadband receiver, of “airspy” type.

In embodiments, the system 100 comprises a concentrator of information transmitted by at least one transmitter 120, this concentrator comprising a transmitter of information directed to the receiver 125.

Preferentially, the receiver 125 is mobile with respect to the terminals 105. This mobility is conferred on the receiver 125 by embedding said receiver 125 aboard a vehicle. Such a vehicle is, for example, a drone, an airplane, a motorbike or a satellite. When the receiver 125 is on board an automatic vehicle, this vehicle can exhibit a road plan, or flight plan, determined automatically as a function of positioning data in respect of the terminals 105 of the system 100.

Preferentially, at least one transmitter 120 is a narrowband transmitter and the receiver 125 is a broadband receiver, configured to pick up the information transmitted by the set of transmitters 120 of the system 100. Preferentially, at least one transmitter 120 is a very-high-frequency or ultra-high-frequency transmitter.

In embodiments, the signal transmitter 120 implements a time division multiple access communication protocol. These embodiments make it possible to avoid a collision of packets emitted by various terminals 105. The transmitter 120 may, or may not, be associated with a clock. In the case of an association of a terminal 105 with the phase of an electrical grid, the transmitter 120 is synchronized with the phase of said electrical grid, for example by detecting the zero-crossing of an alternating current. This phase can, moreover, be stored within the terminal 105, in a computer memory, so as to be able to be implemented even in case of failure of the electrical grid.

In embodiments, at least one terminal 105 is configured to maintain the phase-wise timing of timeslots of the time division multiple access communication protocol in case of outage of access of the terminal to an external signal allowing the terminal to determine a timing phase for the timeslots.

These embodiments are embodied, for example, by a memory implemented in said terminal 105 configured to store an item of information representative of a phase sensed at an instant at which access to the external signal was available.

Alternatively, this phase can be detected on the basis of packets received from the Internet network, from a satellite-based positioning system.

In embodiments, at least one terminal 105 comprises a clock as well as a synchronization device 130 linked to the Internet network, the synchronization device being configured to synchronize the clock with the Internet network.

The clock can be stored at the level of a network card or of a microprocessor, for example. The synchronization device 130 is, for example, a computer program embedded inside the network card or the micro-processor, this computer program controlling the synchronization of the clock with a clock external to the terminal 105.

In embodiments, the terminal 105 is linked to a clock radio-transmission system, by way of a radio signals receiver (not referenced). The synchronization device 130 is then configured to synchronize the clock with the clock radio-transmission system. To carry out this action, the synchronization device 130 reads, in a packet transmitted by the radio-transmission system, a clock value and applies this clock value to the terminal 105. Clock synchronization mechanisms are well known to the person skilled in the art and are not repeated here.

In embodiments, the terminal 105 is linked to a satellite-based position system, of GPS (for “Global Positioning System”) type for example, the synchronization device 130 being configured to synchronize the clock with the satellite-based position system. In these embodiments, the terminal 105 preferentially comprises a receiver (not referenced) of signals emitted by the satellite-based positioning system. To carry out this synchronization, the synchronization device 130 reads, in a packet transmitted by the satellite-based positioning system, a clock value and applies this clock value to the terminal 105. Clock synchronization mechanisms are well known to the person skilled in the art and are not repeated here.

An exemplary transmitter 120 is described, but not referenced, in relation to FIGS. 1 to 5, as regards the terminals 12 and 12′.

In alert mode, the terminals 105 preferentially emit the frames with a periodicity corresponding at the minimum to the sum of all the durations of the time windows, thereby corresponding to the case where a complete message can fit inside a single frame. In the other cases, the periodicity is the product of the sum of all the durations of the time windows with the number of frames which constitute a complete message.

Techniques for optimal sharing of frequencies can be combined with time sharing techniques, since the frames to be transmitted are short compared with the duration of visibility of a black box by the vector carrying the receiver. The number of RF transmission channels is then the product of the possible number of frequency-wise channels and the number of time windows.

If the duration of the visibility of a terminal 105 by the mobile receiver 125 equals several times the emission periodicity of the terminal 105, then there is redundancy of messages, and techniques, of accumulation in particular, can exploit this redundancy to improve the signal-to-noise ratio and the RF detection of the frames.

Preferentially, at least one receiver 125 operates in broadband and picks up the totality of the signals in radio visibility. The separation of the frequency channels and/or temporal channels, being able to be carried out subsequently, either within the receiver 125 so as to reduce the data volume to be transmitted, or downstream by a computer system 300, by decomposition of the dynamic spectrum of the raw signal recorded. The reduction of the volume of data to be retransmitted decreases greatly which is useful for the use of satellites.

At least one terminal 105 can be used as concentrator to group together the information originating from other, so-called “auxiliary”, terminals, in which cases these terminals are connected together, either by wired link, or by wireless link (Wifi, radiofrequencies), so as to limit the number of emitters in a geographical sector.

In embodiments, at least one radiocommunication terminal 105 is configured to dispatch radiocommunication signals in a shared frequency band, said terminal comprising a sensor 135 of phase of an electrical grid connected to the terminal, said terminal being configured to carry out a temporal division of the shared frequency band into several timeslots per period of the electrical grid, each timeslot having a known ratio to the phase of the electrical grid, the transmitter 120 being configured to transmit on the shared frequency band in the timeslots in compliance with a time division multiple access TDMA schedule.

Such a terminal 105 is described in relation to FIGS. 1 to 5, under the references 12 and 12′.

In embodiments, at least one terminal 105 comprises a clock and/or a phase synchronization device 130 linked to the electrical grid phase sensor 135. Such a synchronization is described in relation to FIGS. 1 to 5.

In embodiments, at least one terminal 105 comprises a reserve 140 of energy allowing the terminal to operate in an autonomous manner. This energy reserve 140 is, for example, a battery or an electrical energy accumulator.

In embodiments, at least one terminal 105 is configured to maintain the phase-wise timing of the timeslots in case of outage of the electrical grid or in case of abrupt change of the phase of the electrical grid.

In embodiments, at least one receiver 125 comprises an emitter 126 of a command to stop transmission directed to at least one terminal 105, each terminal 105 ceasing to transmit signals on receipt of said command.

Preferentially, at least one terminal 105 is associated with a terminal identifier, determined during the manufacture of said terminal 105 or allotted by the computer system 300. The receiver 125 may, or may not, know at least one terminal identifier and associate at least one of said identifiers with the stop command. When a terminal 105 receives a stop command, a verification of the correspondence between the terminal identifier of the command and the terminal identifier recorded in the terminal 105 takes place. If the terminal 105 determines that the identifiers correspond, the transmission of signals ceases. This cessation can be carried out at the level of the transmitter or of a central processor for actuation of said terminal 105.

Such an embodiment is described in relation to FIGS. 1 to 5.

In embodiments, the electrical grid phase sensor 135 comprises a connector 145 that can be hooked up to the electrical grid.

Such an embodiment is described in relation to FIGS. 1 to 5.

In embodiments, the electrical grid phase sensor 135 comprises an antenna 150 to pick up the oscillations of the electrical grid.

Such an embodiment is described in relation to FIGS. 1 to 5.

In embodiments, at least one terminal 105 comprises a wired or wireless communication module 155 to connect to a local network and/or to the Internet.

Such an embodiment is described in relation to FIGS. 1 to 5.

In embodiments, the system 100 which is the subject of the present invention comprises at least one sensor 400 linked to at least one terminal 105, the transmitter 120 being configured to emit an item of information representative of a value sensed by at least one said sensor 400. At least one sensor 400 is, for example:
a presence sensor,
a sensor of a determined physical quantity, such as smoke, fire, water or gas for example
a sensor of presence of mobile telephones in proximity,
a sensor of presence of peripherals associated with a Wifi or Bluetooth network in proximity.

In embodiments, at least one sensor 400 is a mobile telephone presence sensor. Such a sensor 400 implements, for example, an antenna configured to receive signals emitted on a cellular telephone network frequency and a detector of a signal power received by said antenna, a presence being determined for each signal whose said signal power received is greater than a determined limit value.

In embodiments, at least one terminal 105 comprises:
a receiver 121 of message emitted on a local network including said terminal 105, preferentially wireless and
a memory 122 for at least one said message,
   the transmitter 120 being configured to emit at least one signal representative of at least one said message.

The receiver 121 is, for example, a wireless antenna operating on a local network of Wifi type. Alternatively, the local network is a wired local network. The transmitter emits, for example, the stored messages or an indicator of a stored message accessible on request of the receiver 125.

In embodiments, the system which is the subject of the present invention comprises a plurality of terminals 105, at least two of which terminals are linked together by a radiocommunication link, at least one terminal forming concentrator of signals emitted by the two said terminals.

The term “concentrator” signifies that the so-called concentrator terminal records signals to be transmitted on behalf of each non-concentrator terminal associated with said concentrator terminal. The transmission of these signals can be done in full, or limited to the transmission of an indicator of these signals.

In embodiments, at least one terminal 105 comprises a wired or wireless communication module 155 to connect to sensors 400, receive data from these sensors and upload the data to a serving station via the radiocommunication signals in the shared frequency band.

Such an embodiment is described in relation to FIGS. 1 to 5.

In embodiments, at least one terminal 105 comprises a buffer memory 160 to save data of connected sensors.

Such an embodiment is described in relation to FIGS. 1 to 5.

In embodiments, the receiver 125 is configured to listen to the shared frequency band.

Such an embodiment is described in relation to FIGS. 1 to 5.

In embodiments, at least one terminal 105 and the receiver 125 are synchronized with one and the same electrical grid.

Such an embodiment is described in relation to FIGS. 1 to 5.

In embodiments, the receiver 125 is mounted on a vehicle 200.

Such an embodiment is described in relation to FIGS. 1 to 5.

In embodiments, the vehicle 200 is a drone or a car.

Such an embodiment is described in relation to FIGS. 1 to 5.

Thus, as is understood, the system 100 operates in the following manner:

A set of terminals 105 is positioned geographically on a site to be protected by operators. An item of positioning information in respect of the terminals 105 is thereafter stored at the level of the system 100, either in a memory of each said terminal 105, or in a memory of a dedicated computer system, embedded in the receiver 125 or linked to said receiver 125. This item of positioning information associates an identifier of terminal 105 with an item of positioning information. This item of positioning information can be geographical, via the incorporation of a device of GPS type in the terminal 105, or of positioning on a data network, such as an IP address for example. The identifier of terminal 105 can be determined during the manufacture of said terminal 105 or configured manually by an operator or automatically, via the computer system generating identifiers.

These terminals 105 thus operate in the manner of aeronautical black boxes. When a terminal 105 determines a failure of a network to which this terminal 105 is connected, this terminal 105 emits an alert signal directed at the receiver 125. The receiver 125 then notifies a human operator or another data system connected to the receiver 125. This notification allows, for example, the dispatching of emergency aid into priority zones, or the dispatching of additional receivers 125.

We detail, hereinafter, an exemplary manner of operation of the system 100 which is the subject of the present invention:

To cope with an earthquake in California, the city of San Francisco equips certain buildings with a network of prepositioned fixed terminals 105. These terminals 105 permanently collect physical parameters, for example the ambient temperature, as well as the presence of mobile telephones in proximity.

During a disaster, electricity and the usual means of communication are out of service.

A large number of terminals 105 are then disconnected from the Internet and/or detect a strong phase shift on the electrical energy, due to an electrical energy generator being turned on. These terminals 105 pass to “alert” mode. These terminals 105 emit, in a loop, signals around 225 MHz, in the temporal and frequency channel which they were allotted beforehand as a function of their location, and, as long as there is energy available in the batteries.

A computer system, linked to mobile receivers 125, detects the absence of response of a large number of terminals 105 on a data network linking terminals 105 and computer system. Human intervention may be necessary to validate the presence of an event. In case of absence of response, the computer system configures flight plans for drones, furnished with receivers 125, to collect data preferentially in the zone of the calamity and record the information thus collected for the ground segment.

In less than two hours, the first data are collected. The modulation traces which were detected on board are analyzed, for example to remove redundancies, detect evolutions, etc. It is possible to indicate, on a map, human presence, fires, floods etc. Detection and processing remain possible as long as there is energy in the terminals 105 when terminals 105 and receivers 125 are within range of one another.

If the receiver 125 is embedded on board a satellite, each satellite must preferentially be of a the size of a few cubic decimeters and weigh less than ten kilograms. The dimensioning factor is the receiving antenna since the link budget presents management difficulties. Such satellites preferentially fly at low altitude (500-800 km) so as to limit energy consumption, to pass back frequently over one and the same zone and to be economical to launch. The number of satellites depends on the geographical expanse to be covered with the system 100.

Preferentially, a 2 GHz transceiver is necessary for the remote control, telemetry of the terminals 105.

FIG. 1 shows, in a schematic manner, a telecommunications system 10 comprising terminals 12 and 12′, a drone 14 acting as mobile serving station, a pylon 16 acting as stationary serving station and a control center 18.

In the embodiment illustrated, the terminals 12, 12′ are connected to sensors 20 (by wire or wirelessly) and act as telecommunications relay. The terminals 12, 12′ may be connected to the Internet 22 and may possess an IP address. According to a preferred embodiment, the terminals 12, 12′ are configured as domestic routers.

The terminals 12, 12′ are hooked up to the electrical grid 24. They have an energy reserve, for example an accumulator or a battery 26 powered by a charger 28, which allows them to operate in case of current outage.

The terminals 12, 12′ can be configured to transmit their messages using the Internet network 22.

In the case where Internet access is unavailable or prohibited (this could be the case permanently for a given terminal), the terminals 12, 12′ place themselves in a mode of operation (for example an alert mode) in which the messages containing the data to be transmitted destined for the control center 18 are dispatched through a common frequency resource, that is to say a shared radiofrequency band. In this case, the terminals 12, 12′ transmit their messages in the form of radioelectric signals which are received by a serving station 14, 16 and relayed by the latter to the control center 18.

This second mode of operation will be described in greater detail hereinafter. Each terminal is equipped with a sensor of phase of the electrical grid, thereby allowing it to synchronize with the electrical grid 24. The frequency of the electrical grid 24 being maintained tightly at its nominal frequency (normally 50 Hz or 60 Hz) by the operators, all the terminals 12, 12′ are mutually synchronized by transitivity. In preferential variants, the terminals 12, 12′ emit on the shared frequency band while complying with a TDMA schedule.

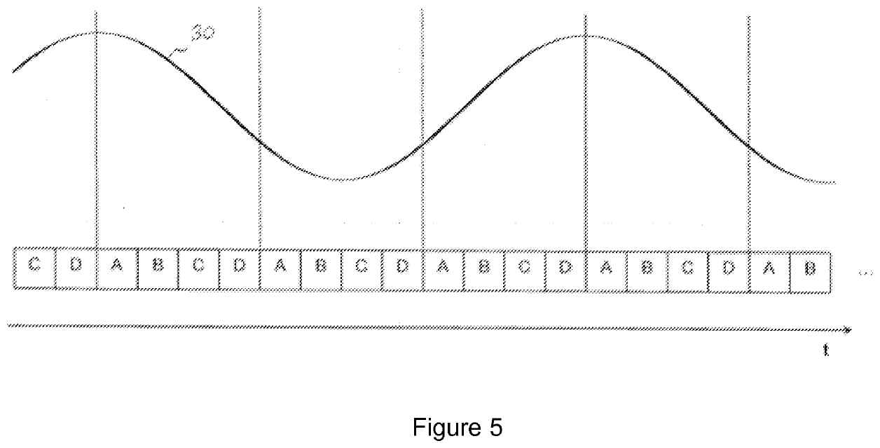

FIG. 5 illustrates how a TDMA schedule can be synchronized with the electrical grid. The reference number 30 designates the sinusoidal voltage of the phase conductor taken as reference. The electrical grid is assumed to employ three phases (three-phase current) mutually shifted by 120°. As explained above, there therefore exists a priori an uncertainty as regards the phase to which a terminal is synchronized. To take account of this, each period of the alternating current is divided into N slots, N being a multiple of 3 (in the case of FIG. 5, N=12) and the number of independent TDMA channels is fixed at n=N/3. In FIG. 5, the TDMA channels, which are 4 in number, are denoted A to D. The base pattern A-B-C-D repeats at triple the frequency of the alternating current. Henceforth, each terminal synchronizing in this way with one of the three phases of the three-phase network produces the same division of the time.

The TDMA schedule defining which terminal is entitled to use which timeslot(s) for the transmission of its messages is known to the control center and possibly to the serving stations. On the terminals side, each terminal knows at least which timeslot it is entitled to use at which moment. For a given terminal, the schedule is advantageously static, that is to say fixed once and for all, for example when brought into service at the place of installation, preferably as a function of the assignment of the slots to the geographically neighboring terminals. For example, if, in the neighborhood of the place of installation of a terminal, there exists another terminal which uses channel A, channel C will preferably be assigned to the new terminal, the latter being furthest from channel A. If there are other terminals in the neighborhood, their transmission slots are also taken into account. According to one embodiment of the telecommunication method, each terminal can emit on its allocated channel at any moment. It is however clear that onward of a certain geographical density of the terminals, collisions between messages of various terminals having access to the same channel cannot be excluded with certainty, except by taking additional measures to adjust access. Other embodiments of the telecommunication method can therefore make provision for additional restrictions on the transmission of messages so as to reduce the probability of collisions. For example, the maximum length of a message can be defined as can the maximum number of messages that a terminal is entitled to emit per unit time.

The TDMA schedule is stored in a database 32 of the control center 18. The database 32 can be a centralized database (as shown by FIG. 1) or decentralized database. Authorized users, for example the serving stations 14, 16, can consult the TDMA schedule (or a part of the latter) by way of a server 34 connected to the Internet 22 and/or to a local network.

Preferably, each serving station knows the timeslots and possibly the frequency sub-bands liable to contain messages of the terminals in their coverage zone. This allows them to monitor the radiofrequency band more effectively than without a priori knowledge of the TDMA schedule. However, it is also possible to use a broadband serving station capable of monitoring the whole electromagnetic spectrum liable to be used by the terminals.

In variants, the terminals 105 emit on a shared frequency band according to an FDMA mode where frequency sub-bands are allotted to each terminal 105, either during manufacture, or dynamically. This allotting can be carried out automatically by the central computer system 300 when setting the system 100 into operation. This allotting can be carried out subsequent to a step of determining the frequency sub-bands to be allotted to each terminal, so that as a function of the geographical positioning of each said terminal 105 and of the effective range of radio communication envisaged, two terminals 105 do not emit in one and the same frequency sub-band if these two terminals 105 are close. The allotting can be carried out by the implementation of the data network linking terminals 105 and central computer system 300.

In variants, the terminals 105 emit on a shared frequency band according to an FDMA mode and a TDMA mode. In variants, the terminals 105 emit on a shared frequency band according to a CDMA mode. In these variants, the same allotting mechanics can be carried out to avoid collisions.

A system as shown by FIG. 1 can serve as infrastructure for multiple applications, for example telemonitoring, remote logging of meters, launching of alerts, etc. Service providers can, for example, install sensors 20 and connect them (by wire or wirelessly) to a terminal 12. The data of the sensors 20 are processed by the microprocessor 36 of the terminal 12 for retransmission to the control center 18. This retransmission can be done through the Internet 22 or by radiocommunication to a serving station 14, 16. At the control center 18, the data of all the terminals 12, 12′ are processed, stored and/or forwarded (for example to the service providers). It is noted that the data of the sensors 20 could be encrypted so that only the service provider can read them.

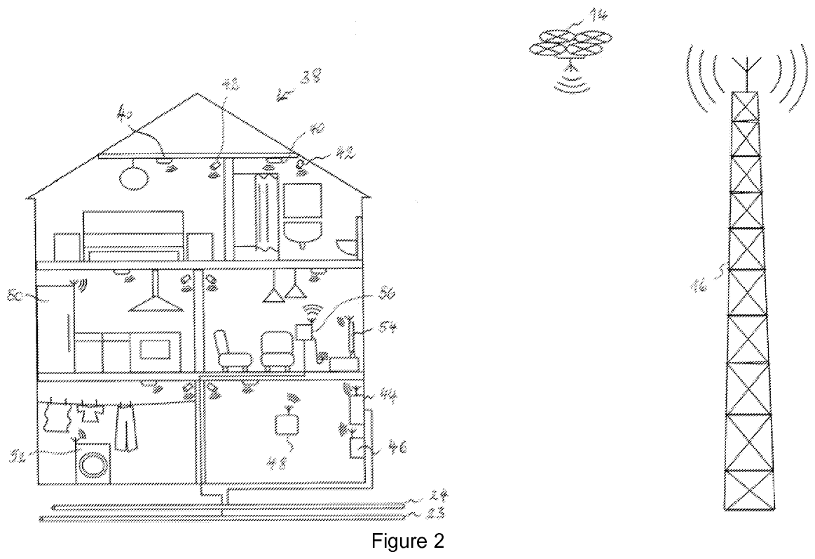

FIG. 2 shows an “intelligent” house 38 equipped with numerous devices capable of communicating. These connected devices comprise, in the case illustrated, smoke detectors 40, presence detectors 42, a meter 25 for electricity 44, a gas meter 46, a water meter 48, a refrigerator 50, a washing machine 52, a television 54 and a domestic router 56 which is configured as a terminal such as described above and also representing a Wifi access point.

The router 56 can operate in different modes of operation. In a first mode of operation, the router 56 retransmits the data of the sensors via an Internet link 23. In a second mode of operation, the router 56 retransmits all or only some of the data of the connected devices by radio to a serving station 14, 16, by using a TDMA protocol such as described above. The router 56 is programmed so as to place itself in the second mode of operation as soon as there is an outage of the Internet link 23 and/or of the supply of current.

The router 56 comprises an internal clock that it synchronizes to the electrical grid 24 as well as an energy reserve (see FIG. 1). In case of outage of the current, the energy reserve allows the router to operate, in particular, to supply its internal clock with energy, to receive data of connected devices capable of operating in an autonomous manner, to process these data and to retransmit them by radio. The internal clock allows it to maintain synchronization with the other terminals and the serving stations at least for a certain time.

The capacity of the terminals to operate in an autonomous manner has a beneficial application in the field of search and rescue of people in case of natural catastrophe or catastrophe of human origin (for example earthquake, tornado, tsunami, flood, explosion, fire, etc.). In such an application, the terminals act as radiobeacons for locating people or relaying other critical information. Each terminal stores the data of the connected presence detectors in a buffer memory. As and when new data are received, they are recorded and replace the older data. The collection of new data is, however, interrupted as soon as the terminal passes to the alert mode so as to prevent potentially corrupted data overwriting the latest valid data. Thus, in case of calamity, the terminals can transmit messages indicating, for example, the number of people present and their location. The emergency aid services preferably use a drone 14 configured as a serving station to overfly a ravaged zone and to collect information. The coordination of search and rescue operations will be able to be based, inter alia, on this information.

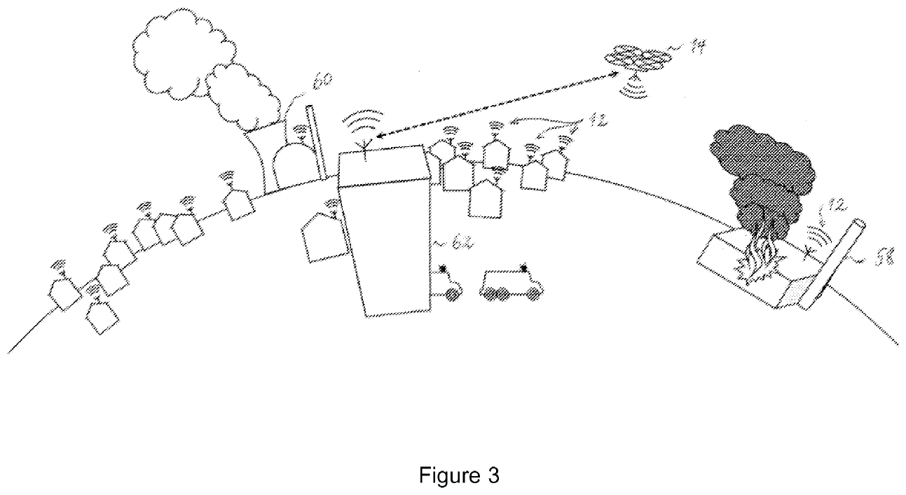

FIG. 3 illustrates the use of a telecommunication system according to one embodiment of the invention within the framework of an emergency situation. In risk zones, for example around the Seveso site 58 and its surroundings, in a nuclear installation 60 and its surroundings, etc. the telecommunication system is particularly useful for conveying information to an intervention and rescue coordination center 62. In case of accident 64, the emergency aid services can overfly the calamity-stricken zone with a drone 14 and thus collect the messages transmitted by the terminals 12.

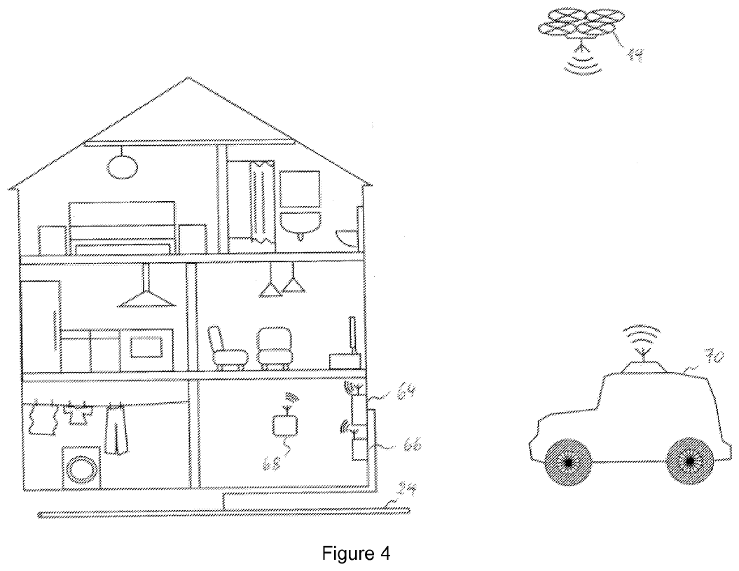

FIG. 4 shows another application of a telecommunication system according to a very beneficial embodiment of the invention. In the examples of FIGS. 1 and 2, the terminals serve as relays or as information routers. In the example of FIG. 4, the terminals are integrated into the devices from which the information to be transmitted originates, in particular into an electricity meter 64, a gas meter 66 and water meter 68. Each of these devices communicates its information to a serving station in an individual manner. Each of the devices synchronizes with the electrical grid and emits while complying with the TDMA schedule. The fact that the terminals are synchronized is of great benefit, since the probability of collisions is thereby automatically reduced with respect to an asynchronous system. It should be noted that the probability of collisions is already reduced on account of the simple fact of introducing a granularity of the time, that is to say on account of the fact of imposing slots to be complied with. The probability of collisions can be yet further reduced by the intelligent allocation of slots or of groups of slots to the terminals. The meters are preferably read with the help of a mobile serving station, mounted e.g. on a drone 14 or a car 70. Optionally, the mobile serving station can emit a signal triggering the emission of the messages by the terminals that have received the signal. An advantage of this approach would be that the terminals concerned do not need to emit their messages regularly but can remain silent most of the time.

Like the terminals, the serving stations can also be designed to synchronize to the mains. A mobile serving station can be synchronized to the mains before embarking on its mission—in this case, the internal clock of the mobile station is synchronized with the mains for a certain time. When the mobile station is unplugged, the internal clock will allow it to remain synchronized with the terminals for a certain time, which depends on the quality of the internal clock. Another possibility of keeping a mobile station synchronized while it is on its mission is to establish a communication channel transmitting a clock signal from a monitoring center to the mobile station.

Whilst particular embodiments have just been described in detail, the person skilled in the art will appreciate that diverse modifications and alternatives to them can be developed in the light of the overall teaching afforded by the present disclosure of the invention. Consequently, the specific arrangements and/or methods described herein are presumed to be given solely by way of illustration, with no intention of limiting the scope of the invention.

1. A system for alert and disaster management, comprising:
at least one radiocommunication terminal, the terminal comprising:
a means of communication, via a data network, with a central computer system,
a sensor of a value of a physical quantity representative of the operation of the network connected to the terminal,
a means for determining a failure of the network as a function of the sensed value,
a transmitter of radio signals in case of failure determination and
the central computer system, linked via the data network to at least one terminal, comprising:
a memory for information in respect of geographical positioning of at least one terminal,
a detector of anomaly of network link between the computer system and at least one terminal,
a means for providing an alert in case of anomaly,
a means for providing an item of information representative of the stored positioning of at least one said terminal exhibiting a network link anomaly and
at least one mobile radiocommunication receiver configured to receive the radio signals emitted by at least one terminal.

2. The system as claimed in claim 1, wherein the computer system comprises a device configured to prepare an itinerary of at least one receiver, the itinerary being established as a function of at least one item of geographical positioning information provided.

3. The system as claimed in claim 1, in which the computer system comprises a satellite control device configured to control a satellite, said satellite being a mobile radiocommunication receiver.

4. The system as claimed in claim 1, wherein the sensor is configured to sense a physical quantity representative of an Internet network.

5. The system as claimed in claim 1, in which the sensor is configured to sense a physical quantity representative of an electrical grid.

6. The system as claimed in claim 1, wherein the transmitter of radio signals is configured to implement a time division multiple access communication protocol.

7. The system as claimed in claim 6, wherein at least one terminal is configured to maintain the phase-wise timing of timeslots of the time division multiple access communication protocol in case of outage of access of the terminal to an external signal allowing the terminal to determine a timing phase for the timeslots.

8. The system as claimed in claim 6, wherein at least one terminal comprises a clock as well as a synchronization device linked to the Internet network, the synchronization device being configured to synchronize the clock with the Internet network.

9. The system as claimed in claim 6, wherein at least one terminal comprises a clock as well as a synchronization device linked to a clock radio-transmission system, the synchronization device being configured to synchronize the clock with the clock radio-transmission system.

10. The system as claimed in claim 6, wherein at least one terminal comprises a clock as well as a synchronization device linked to a satellite-based position system, the synchronization device being configured to synchronize the clock with the satellite-based position system.

11. The system as claimed in claim 6, wherein at least one radiocommunication terminal is configured to dispatch radiocommunication signals in a shared frequency band, said terminal comprising a sensor of phase of an electrical grid connected to the terminal, said terminal being configured to carry out a temporal division of the shared frequency band into several timeslots per period of the electrical grid, each timeslot having a known ratio to the phase of the electrical grid, the transmitter being configured to transmit on the shared frequency band in the timeslots in compliance with a time division multiple access schedule.

12. The system as claimed in claim 11, wherein at least one terminal comprises a phase synchronization device linked to the sensor of phase of the electrical grid.

13. The system as claimed in claim 12, wherein at least one terminal comprises an energy reserve allowing the terminal to operate in an autonomous manner, the at least one terminal configured to maintain the phase-wise timing of the timeslots in case of outage of the electrical grid or in case of abrupt change of the phase of the electrical grid.

14. (canceled)

15. The system as claimed in claim 11, wherein the sensor of phase of the electrical grid comprises at least one of a connector that can be hooked up to the electrical grid and an antenna to pick up the oscillations of the electrical grid.

16. (canceled)

17. The system as claimed in claim 11, wherein at least one terminal comprises a wired or wireless communication module to connect to a local network and/or to the Internet.

18. The system as claimed in claim 11, wherein at least one terminal comprises a wired or wireless communication module configured to connect to sensors, receive data from these sensors and upload the data to a serving station via the radiocommunication signals in the shared frequency band.

19. (canceled)

20. (canceled)

21. The system as claimed in claim 11, wherein the receiver is configured to listen to the shared frequency band and in which at least one terminal and the receiver are synchronized with one and the same electrical grid.

22. The system as claimed in claim 1, wherein the receiver is mounted on a vehicle.

23. (canceled)

24. (canceled)

25. The system as claimed in claim 1, which comprises at least one sensor linked to at least one terminal, the transmitter being configured to emit an item of information representative of a value sensed by at least one said sensor, the at least one sensor comprising a mobile telephone presence sensor.

26. (canceled)

27. The system as claimed in claim 1, wherein at least one terminal comprises:
a receiver of a message emitted on a local network including said terminal; and
a memory for at least one said message,
the transmitter being configured to emit at least one signal representative of at least one said message.

28. The system as claimed in claim 1, which comprises a plurality of terminals, at least two of which terminals are linked together by a radiocommunication link, at least one terminal forming concentrator of signals emitted by the two said terminals.

29. (canceled)
